(19) United States
(12) Patent Application Publication
(10) Pub. No.: US 2013/0266119 A1
(43) Pub. Date: Oct. 10, 2013

(54) MICRO-FOCUS X-RAY GENERATION APPARATUS AND X-RAY IMAGING APPARATUS

(71) Applicant: CANON KABUSHIKI KAISHA, Tokyo (JP)

(72) Inventors: Osamu Taniguchi, Chigasaki-shi (JP); Takao Ogura, Yokohama-shi (JP)

(21) Appl. No.: 13/857,749

(22) Filed: Apr. 5, 2013

(30) Foreign Application Priority Data
Apr. 10, 2012 (JP) 2012-089700

(51) Int. Cl. H01J 35/14; G01N 23/04

(52) U.S. Cl. CPC H01J 35/14; G01N 23/04
USPC 378/62; 378/121; 378/111

(57) ABSTRACT

A transmission type micro-focus X-ray generation apparatus includes an electron reflector, an electron passage surrounded by the electron reflector, an electron source, and a target. X-rays are generated by irradiating the target with electrons that have been emitted from the electron source and that have passed through the electron passage. The electron passage has a conical shape having a cross-sectional area that increases from an outlet on the target side toward an inlet on the electron source side. A material of the target is molybdenum, tantalum, or tungsten. The atomic number of a material of the electron reflector is greater than or equal to the atomic number of the material of the target.

### BACKGROUND OF THE INVENTION

1. Field of the Invention

The present invention relates to a micro-focus X-ray generation apparatus and an X-ray imaging apparatus including the micro-focus X-ray generation apparatus, which are used for nondestructive radiation imaging in medical and industrial fields.

2. Description of the Related Art

There are transmission type X-ray tubes that generate X-rays from a surface of a target opposite to an electron irradiation surface of the target by irradiating the electron irradiation surface with electrons emitted from an electron source.

Japanese Patent Application Laid-Open No. 09-171788 describes a transmission type micro-focus X-ray tube including an anode member which faces an electron source. The anode member includes a conical channel in which an inlet opening is larger than an outlet opening. Japanese Patent Application Laid-Open No. 07-057668 describes an X-ray target in which an X-ray generator is integrally formed with a housing made of a material which is the same as that of the X-ray generator.

To date, the combination of the material of a target and the material of a cone-shaped channel of micro-focus X-ray generation apparatuses has not been appropriately selected. As a result, efficiency in the use of electrons reflected by a cone-shaped channel has not been sufficiently high.

### SUMMARY OF THE INVENTION

The present invention provides a transmission type micro-focus X-ray generation apparatus in which the efficiency in use of reflected electrons is increased by appropriately selecting the combination of the material of a target and the material of an electron reflector.

According to an aspect of the present invention, a transmission type micro-focus X-ray generation apparatus includes an electron reflector, an electron passage surrounded by the electron reflector, an electron source, and a target. X-rays are generated by irradiating the target with electrons emitted from the electron source and that have passed through the electron passage. The electron passage has a conical shape having a cross-sectional area that increases from an outlet on the target side toward an inlet on the electron source side. A material of the target is molybdenum, tantalum, or tungsten. The atomic number of a material of the electron reflector is greater than or equal to the atomic number of the material of the target.

With the present invention, the efficiency in generating X-rays with the target can be increased, and thereby a micro-focus X-ray generation apparatus having a high X-ray output power can be provided.

Further features of the present invention will become apparent from the following description of exemplary embodiments with reference to the attached drawings.

### BRIEF DESCRIPTION OF THE DRAWINGS

FIGS. 1A and 1B are schematic views of an anode unit according to the present invention.

FIG. 2 is a schematic view of an X-ray generation apparatus according to the present invention.

FIG. 3 is a block diagram of the X-ray generation apparatus according to the present invention.

### DESCRIPTION OF THE EMBODIMENTS

Hereinafter, an embodiment of the present invention will be described with reference to the drawings. In the present embodiment, X-rays are used as radiation. Alternatively, neutron radiation or gamma rays may be used.

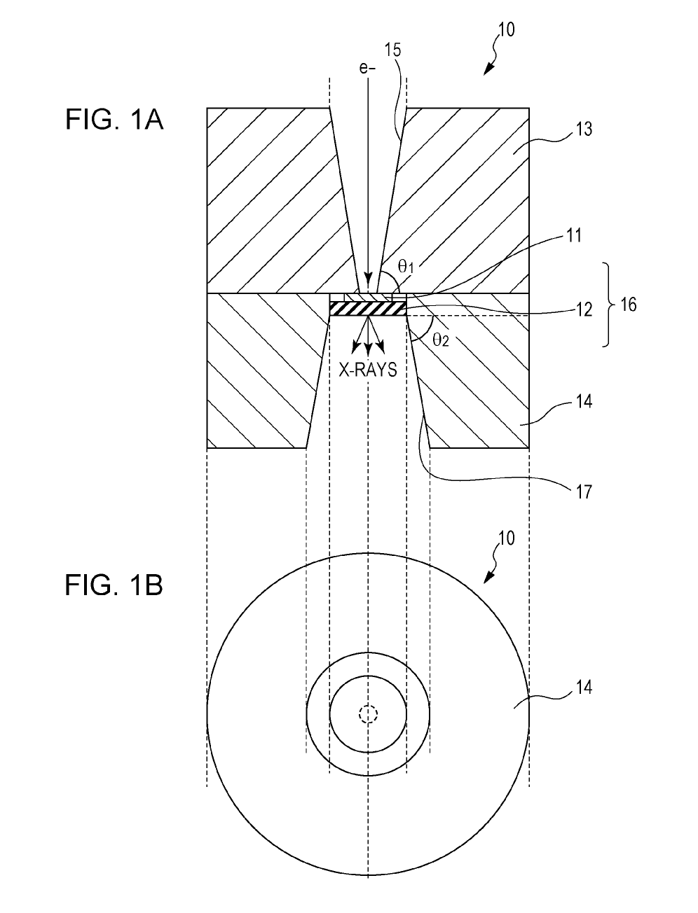

FIGS. 1A and 1B are schematic views of an anode unit 10. To be specific, FIG. 1A is a sectional view taken along a plane parallel to a direction in which an electron beam e− travels, and FIG. 1B is a bottom view of the anode unit 10. A target portion 16 includes an insulating substrate 12 and a target 11 formed on the substrate 12. The substrate 12 is made of a material which has high thermal conductivity, such as diamond. The substrate 12 has a diameter in the range of 3 to 7 mm, and a thickness in the range of 0.5 to 2.0 mm. The target 11 is formed on a surface of the substrate 12 irradiated with the electron beam e−. The target 11 has a diameter in the range of 0.5 to 1.5 mm, and a thickness in the range of 1 to 100 μm. The target 11 may be made of a material having a high melting point and high efficiency in generating radiation, such as tungsten, tantalum, or molybdenum. A metal layer made of titanium or chromium and having a thickness in the range of 0.05 to 1 μm may be disposed between the substrate 12 and the target 11 as an intermediate layer. The metal layer functions as an adhesion layer for increasing adhesion between the substrate 12 and the target 11. The metal layer may also function as an electrode for connecting the target to an external circuit for determining the electric potential of the target 11.

An electron reflector 13 includes a tapered electron passage 15 extending from an electron inlet port to the target 11. The electron reflector 13 is disposed on a side (first side) of the target portion 16 on which electrons are incident (on the inner side of the target portion 16). The electron reflector 13 is made of a material having an atomic number that is greater than or equal to the atomic number of the material of the target 11. Because the electron reflectivity of a material is positively correlated with the atomic number of the material, when such a combination of materials is used, the electron reflectivity of the electron reflector 13 is greater than or equal to that of the target 11. Tungsten or gold is used as the material of the electron reflector 13, when the material of the target 11 is tungsten. Tantalum, tungsten, or gold is used as the material of the electron reflector 13, when the material of the target 11 is tantalum. Molybdenum, silver, gold, tantalum, or tungsten is used as the material of the electron reflector 13, when the material of the target 11 is molybdenum. In the present embodiment, the material of the target 11 may be the same as the material of the electron reflector 13. The material of both of the target 11 and the electron reflector 13 may be tungsten or tantalum.

The electron passage 15 has a conical shape having a cross-sectional area that increases from an outlet on the target side 11 toward an inlet on the electron source side. Because the electron passage 15 has a conical shape, electrons that are not directly incident on the target 11 from the electron source can be guided to the target 11 by making the electrons be bounced and reflected multiple times by the wall of the electron passage 15. The length of the conical shape is in the range of 5 to 10 mm. The diameter of an inlet opening, through which electrons enter, is in the range of 1 to 5 mm. The diameter of an outlet opening, through which electrons exit, is in the range of 10 to 500 μm. (The diameter of the outlet opening is selected in accordance with the size of a focal spot that is required.) The diameter L of the inlet opening may be greater than the beam diameter φ of an incident electron beam (which is, for example, in the range of 0.5 to 1.0 mm), and the diameter M of the outlet opening may be less than or equal to the beam diameter (I). The diameter L of the inlet opening and the beam diameter φ, and the diameter M of the outlet opening and the beam diameter φ may have the following relationships.

2≦L/φ≦5, 0.01≦M/φ≦1.0

When the electron passage 15 has a taper angle θ₁ that satisfies 5≦tan θ₁≦60, electrons reflected in the electron passage can be efficiently incident on the target. It is preferable that the taper angle θ₁ satisfy 10≦tan θ₁≦55. The same effect can be obtained when the electron passage 15 has, instead of a conical shape, a pyramidal shape having a rectangular or polygonal cross section, as long as the conditions for the taper angle θ₁ are satisfied.

An X-ray shield 14 is disposed on another side (second side) of the target portion 16 so as to face the electron reflector 13 with the target portion 16 therebetween (on the outer side of the target portion 16). The X-ray shield 14 includes an X-ray passage 17 that is tapered in a direction opposite from the tapering of the electron passage 15. That is, expressed in another way, the X-ray passage 17 increases its sectional area outward from the target portion 16 to an outlet port thereof. The length of the X-ray passage 17 is in the range of 10 to 50 mm. The diameter of an opening on the substrate 12 side is in the range of 1 to 5 mm. The diameter of an outer opening, which is opposite to the opening on the substrate 12 side, is in the range of 3 to 10 mm. The X-ray shield 14 limits the scattering angle of X-rays radiated from the target 11. The X-ray shield 14 may be made of a material having a high absorption rate for X-rays and a high thermal conductivity, such as tungsten or tantalum. For medical application, the X-ray passage 17 may have a taper angle θ₂ that satisfies 2≦tan θ₂≦20.

The ratio of the diameter of the opening of the X-ray shield 14 on the substrate 12 side (the target 11 side) to the diameter of the outlet opening of the electron passage 15 may be in the range of 10 to 100. In this manner, even with a small focal spot size and a sufficiently large amount of X-rays can be achieved.

The target 11, the electron reflector 13, and the X-ray shield 14 may be made of the same material, such as tungsten, or similar materials. In this case, the efficiency in X-ray radiation, the efficiency in use of reflected electrons, and an effect of blocking unnecessary X-rays can be simultaneously increased. Moreover, in this case, the process of manufacturing the anode unit 10 is simplified.

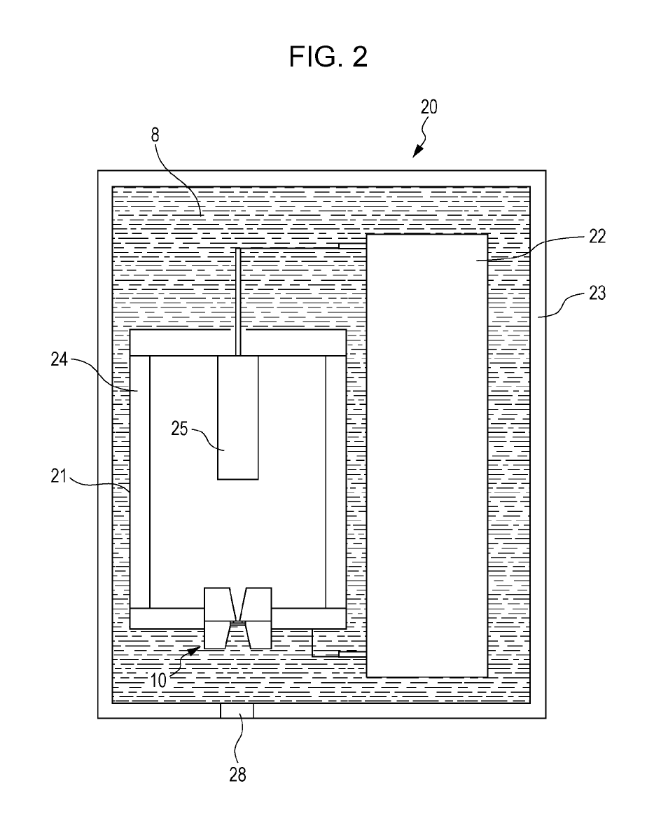

FIG. 2 is a schematic view illustrating the inside of an X-ray generation apparatus 20. The X-ray generation apparatus 20 includes a transmission type X-ray tube 21 and a voltage controller 22, which are disposed in an envelope 23. The X-ray tube 21 includes an electron source 25, which is disposed in a vacuum vessel 24, and the anode unit 10, which is joined to an opening portion of the vacuum vessel 24. An insulating liquid 8 is disposed between the envelope 23 and the vacuum vessel 24. That is, an extra space in the envelope 23 that is not occupied by the vacuum vessel 24 or the voltage controller 22 is filled with the insulating liquid 8. The voltage controller 22 outputs an electric signal to the electron source 25 to control emission of an electron beam, the anode voltage is also controlled by the voltage controller 22. In this manner, generation of X-rays is controlled.

The envelope 23 may have a sufficiently high strength as a container and high heat dissipation capability. The envelope 23 may be made of a metal material, such as brass, steel, or a stainless steel.

The insulating liquid 8 may be an electrically insulating oil (such as a silicone oil or a mineral oil), which can serve as a coolant for cooling the X-ray tube 21.

The envelope 23 has a window 28, through which X-rays can pass and through which radiation is emitted to the outside of the envelope 23. The window 28 is made of glass or aluminium.

The electron source 25 is disposed in the vacuum vessel 24 so as to face the target portion 16. The electron source 25 includes a hot cathode (for example, tungsten filament) or a cold cathode (for example, a carbon nanotube), an extraction electrode, and a lens electrode. The extraction electrode generates an electric field that causes electrons to be emitted, the lens electrode focuses the electrons onto the target 11, and thereby X-rays are generated. Between the electron source 25 and the target 11, an acceleration voltage Va in the range of 40 to 150 kV (kilo volts) is applied.

The vacuum vessel 24, which maintains a vacuum in the X-ray tube 21, is made of glass or ceramic. The degree of vacuum in the vacuum vessel 24 is in the range of 10⁻⁴ to 10⁻⁸ Pa. A getter may be disposed in the vacuum vessel 24 to maintain a vacuum. At the opening portion of the vacuum vessel 24, the X-ray shield 14 having the X-ray passage 17 is disposed in such a way that at least a part of the X-ray shield 14 protrudes toward the envelope 23. The anode unit 10 is joined to the periphery of the opening portion using silver solder.

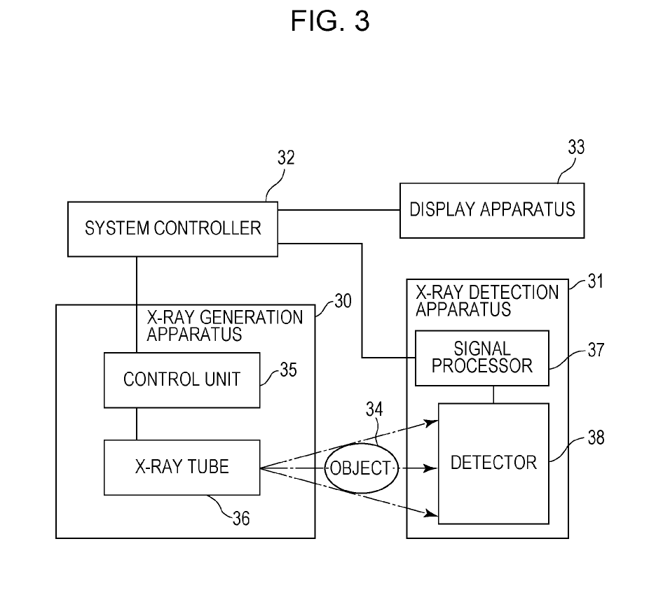

FIG. 3 is a block diagram of an X-ray imaging apparatus. As an X-ray generation apparatus 30, the transmission type micro-focus X-ray generation apparatus according to the embodiment described above is used. A system controller 32 performs cooperative control of the X-ray generation apparatus 30 and an X-ray detection apparatus 31. A control unit 35 outputs various control signals to an X-ray tube 36 under the control by the system controller 32. Emission of X-rays from the X-ray generation apparatus 30 is controlled in accordance with the control signals. X-rays emitted from the X-ray generation apparatus 30 pass through an object 34 and are detected by a detector 38. The detector 38 converts the detected X-rays into an image signal, and outputs the image signal to a signal processor 37. The signal processor 37 performs predetermined signal processing on the image signal under the control by the system controller 32, and outputs the processed image signal to the system controller 32. On the basis of the processed image signal, the system controller 32 outputs a display signal, for making a display apparatus 33 to display an image, to the display apparatus 33. The display apparatus 33 displays an image based on the display signal on a screen as an X-ray image of the object 34.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-089700 filed Apr. 10, 2012, which is hereby incorporated by reference herein in its entirety.

What is claimed is:

1. A transmission type micro-focus X-ray generation apparatus comprising:
an electron reflector;
an electron passage surrounded by the electron reflector;
an electron source; and
a target,
wherein X-rays are generated by irradiating the target with electrons emitted from the electron source and that have passed through the electron passage,
wherein the electron passage has a conical shape having a cross-sectional area that increases from an outlet on the target side toward an inlet on the electron source side, and
wherein the atomic number of a material of the electron reflector is greater than or equal to the atomic number of the material of the target.

2. The X-ray generation apparatus according to claim 1,
wherein the target is formed on an insulating substrate.

3. The X-ray generation apparatus according to claim 1, further comprising:
an X-ray shield disposed so as to face the electron reflector with the target therebetween,
wherein the material of the electron reflector, the material of the target, and a material of the X-ray shield are the same.

4. The X-ray generation apparatus according to claim 1,
wherein the electron passage has a taper angle θ₁ that satisfies 5≦tan θ₁≦60.

5. The X-ray generation apparatus according to claim 1, further comprising:
an X-ray shield that is disposed so as to face the electron reflector with the target therebetween, the X-ray shield including an X-ray passage that is tapered outward from the target side,
wherein a ratio of a diameter of an opening of the X-ray shield on the target side to a diameter of an outlet opening of the electron passage is in the range of 10 to 100.

6. The X-ray generation apparatus according to claim 1, comprising:
an envelope;
an X-ray tube disposed in the envelope; and
a voltage controller disposed in the envelope,
wherein the X-ray tube includes the electron source and an anode unit, the anode unit including the target and the electron reflector,
wherein the voltage controller outputs an electric signal for controlling emission of X-rays to the X-ray tube, and
wherein an extra space in the envelope that is not occupied by the X-ray tube or the voltage controller is filled with an insulating liquid.

7. The X-ray generation apparatus according to claim 1, wherein a material of the target is molybdenum, tantalum, or tungsten.

8. An X-ray imaging apparatus comprising:
a transmission type micro-focus X-ray generation apparatus including
an electron reflector,
an electron passage surrounded by the electron reflector,
an electron source, and
a target,
wherein X-rays are generated by irradiating the target with electrons that have been emitted from the electron source and that have passed through the electron passage,
wherein the electron passage has a conical shape having a cross-sectional area that increases from an outlet on the target side toward an inlet on the electron source side,
wherein a material of the target is molybdenum, tantalum, or tungsten, and
wherein the atomic number of a material of the electron reflector is greater than or equal to the atomic number of the material of the target;
an X-ray detection apparatus that detects X-rays emitted from the X-ray generation apparatus and passed through an object; and
a controller that performs cooperative control of the X-ray generation apparatus and the X-ray detection apparatus.
